(19) United States
(12) Patent Application Publication
(10) Pub. No.: US 2003/0107782 A1
(43) Pub. Date: Jun. 12, 2003

(54) Image reading apparatus

(75) Inventor: Hidetoshi Aoki, Kawasaki-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/006,623

(22) Filed: Dec. 10, 2001

(51) Int. Cl. H04N 1/46

(52) U.S. Cl. 358/509

(57) ABSTRACT

An image reading apparatus includes a CCD sensor which reads an image of an original document and converts the image into an electrical signal, in which an optical axis of light reflected by the original document is adjusted and allowed to project to the CCD sensor, the CCD sensor reads the image of the original document and converts the image into an electrical signal and to output the electrical signal. The image reading apparatus comprises a processing circuit which detects a CCD output value of the CCD sensor which is varied in accordance with a deviation of the optical axis, and an optical axis adjusting mechanism (first mirror and first carriages) which adjusts the optical axis such that an output value detected by the processing circuit becomes an appropriate value. The optical axis adjusting mechanism comprises a mirror which reflects light from the original document in a set direction, a fixing/supporting projection which supports the mirror at a given position, an optical axis adjusting screw which supports the mirror together with the fixing/supporting projection, and which turns the mirror by screwing or loosening the screw, thereby adjusting the optical axis, and an elastic supporting projection 29 which abuts from an opposite surface and elastically supports the mirror in a state in which adjustment by the optical axis adjusting screw is permitted.

### BACKGROUND OF THE INVENTION

1. Field of the Invention

The present invention relates to an image reading apparatus capable of easily resolving image failure which is caused if an optical axis is deviated due to such as variation in parts or assembling operation.

2. Description of the Related Art

In general, a color image reading apparatus (hereinafter referred to as “color scanner”) of a copying machine, facsimile machine and the like comprises a light source for supplying light irradiating a surface of an original document, a plurality of mirrors which reflect light reflected from the surface of the original document in a set direction, a CCD sensor which converts an image of the original document which was reflected by the mirrors and was projected into an electrical signal, and a processing circuit which converts the electrical signal in the CCD sensor digitally.

Such a color scanner uses a halogen lamp which has a high intensity as a light source. Since the halogen lamp has characteristics that output in a low wavelength region is weak, output of a Blue signal of three line (Red, Green, Blue) CCD sensor which uses the low wavelength region becomes decrease. To compensate this, illumination of 100,000 Lx or more is required and thus, it was necessary to focus the amount of light of the halogen lamp.

A monochrome light source has illumination (CCD output) which is stable as compared with peak of 100,000 Lx, e.g., illumination distribution on the surface of the original document with the stable amount of light of 50,000 Lx as shown in FIG. 2, due to the characteristics of a monochrome sensor. Whereas, in the case of a high speed color scanner, it is necessary to increase illumination on the surface of the original document so as to obtain the optimal output (1 to 1.5V) of the three line CCD sensor. Therefore, it was necessary to use the halogen lamp which had a high intensity, and also to obtain illumination distribution having a peak as shown in FIG. 3. The optical axis of light reflecting from the mirror is designed such that the optical axis is aligned with a peak value of the illumination distribution. With this, the mirror 1 is aligned with an optical axis designed value B as shown in FIG. 4, and light reflected by the surface of original document is reflected to a set direction. When the optical axis of light reflected by the mirror 1 is deviated from the optical axis designed value B, an angle θ1 of the mirror 1 is adjusted, and optical axes C and D of the mirror 1 are adjusted to the optical axis designed value B.

In the case of the above art, however, if peak positions of the optical axis designed value B and the illumination on the surface of the original document are deviated from each other, the surface of the original document is decreased, and the CCD output is largely varied, which causes image failure. Especially in the case of a color scanner using the three line CCD sensor, the CCD output in RGB largely differs. Thus, there arose a problem that the difference in the CCD output remarkably led to image failure.

### SUMMARY OF THE INVENTION

The present invention has been accomplished in view of the above problem, and it is an object of the invention is to provide an image reading apparatus capable of appropriately adjusting an optical axis by adjusting an angle of a mirror while confirming an actual CCD output value even if the optical axis is deviated due to variation in parts or assembling operation.

An image reading apparatus according to a first aspect of the present invention comprises an image reading apparatus which includes an image reading sensor for reading an image of an original document and converting the image into an electrical signal, and which adjusts an optical axis of light irradiated and reflected by the original document to project the light on the image reading sensor and reads the image of the original document by the image reading sensor to convert the image into the electrical signal, wherein the image reading apparatus further comprises an output value detecting mechanism which detects an output value of the image reading sensor which is varied in accordance with a deviation in the optical axis.

With the above structure, it is possible to detect an output value of the image reading sensor by the output value detecting mechanism, and to determine a degree of deviation of the optical axis by the output value.

It is preferable that the image reading sensor comprises a CCD sensor.

With this structure, the output value detecting mechanism can reliably detect reduction of the output of a Blue signal which is prone to be generated by the CCD sensor, and it is possible to prevent the output from being reduced.

An image reading apparatus according to a second aspect of the invention comprises an image reading apparatus which includes an image reading sensor for reading an image of an original document and converting the image into an electrical signal, and which adjusts an optical axis of light irradiated and reflected by the original document to project the light on the image reading sensor and reads the image of the original document by the image reading sensor to convert the image into the electrical signal, wherein the image reading apparatus further comprises an output value detecting mechanism which detects an output value of the image reading sensor which is varied in accordance with a deviation in the optical axis, and an optical axis adjusting mechanism which adjusts the optical axis such that the output value detected by the output value detecting mechanism becomes an appropriate value.

With the above structure, the output value of the image reading sensor is detected by the output value detecting mechanism to determine a deviation of the optical axis, and the optical axis is adjusted by the optical axis adjusting mechanism such that the output value becomes an appropriate value. With this, it is possible to precisely adjust the optical axis.

In the image reading apparatus of the second aspect of the invention, it is preferable that the image reading sensor comprises a CCD sensor.

With this structure, the output value detecting mechanism can reliably detect reduction of the output of a Blue signal which is prone to be generated by the CCD sensor, and it is possible to prevent the output from being reduced.

In the image reading apparatus of the second aspect of the invention, it is preferable that the optical axis adjusting mechanism comprises a mirror which reflects, in a set direction, light which is projected to the original document and reflected, a fixing/supporting projection for supporting the mirror at a given position, an optical axis adjusting screw which is provided opposed to the fixing/supporting projection and which supports the mirror together with the fixing/supporting projection, and which is screwed or loosening the screw to turn the mirror such that the optical axis of the light reflected by a surface of the mirror is adjusted, and an elastic supporting projection which abuts against a surface of the mirror opposite to the fixing/supporting projection and the optical axis adjusting screw, and which elastically supports the mirror in a state in which the adjustment by the optical axis adjusting screw is permitted.

With the above structure, the mirror is supported at its three points by the fixing/supporting projection, the optical axis adjusting screw and the elastic supporting projection. The fixing/supporting projection supports the mirror at a given position. The optical axis adjusting screw turns the mirror around the fixing/supporting projection by screwing or loosening the screw, thereby adjusting the optical axis of light reflected by a surface of the mirror. The elastic supporting projection elastically supports the mirror by permitting the turning motion of the mirror by screwing or loosening the screw of the optical axis adjusting screw. With this, the optical axis of the light reflected by the surface of the mirror is precisely adjusted.

In the image reading apparatus of the second aspect of the invention, it is preferable that a halogen lamp is used as a light source, the image reading sensor comprises a three line CCD sensor, the output value detecting mechanism includes a display section which displays a CCD output value, the optical axis adjusting mechanism comprises a mirror which reflects, in a set direction, light which is projected to the original document and reflected, a fixing/supporting projection for supporting the mirror at a given position, an optical axis adjusting screw which is provided opposed to the fixing/supporting projection and which supports the mirror together with the fixing/supporting projection, and which is screwed or loosening the screw to turn the mirror such that the optical axis of the light reflected by a surface of the mirror is adjusted, and an elastic supporting projection which abuts against a surface of the mirror opposite to the fixing/supporting projection and the optical axis adjusting screw, and which elastically supports the mirror in a state in which the adjustment by the optical axis adjusting screw is permitted, and wherein an angle of the mirror is adjusted by turning the optical axis adjusting screw of the optical axis adjusting mechanism while confirming the CCD output value on the display section, thereby adjusting the optical axis.

With the above structure, it is possible to easily and precisely adjust the optical axis of the light reflected by the mirror.

### BRIEF DESCRIPTION OF THE DRAWINGS

FIG. 1 is a schematic view showing a structure of an image reading apparatus according to an embodiment of the present invention;

FIG. 2 is a graph showing an illumination distribution on a surface of an original document by a light source for monochrome;

FIG. 3 is a graph showing an illumination distribution on a surface of an original document by a light source for color;

FIG. 4 is a schematic view showing a structure of an adjusting example of an optical axis of a conventional image reading apparatus; and

FIG. 5 is an enlarged view of a portion A of the image reading apparatus shown in FIG. 1.

### DESCRIPTION OF THE PREFERRED EMBODIMENTS

The best embodiment of an image reading apparatus according to the present invention will be explained with reference to the accompanying drawings below.

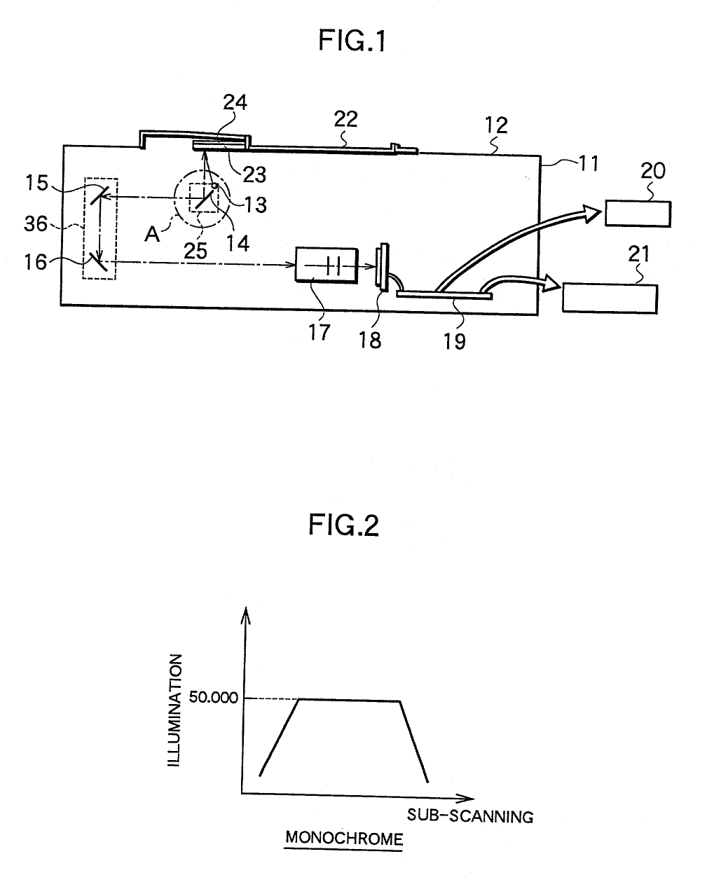

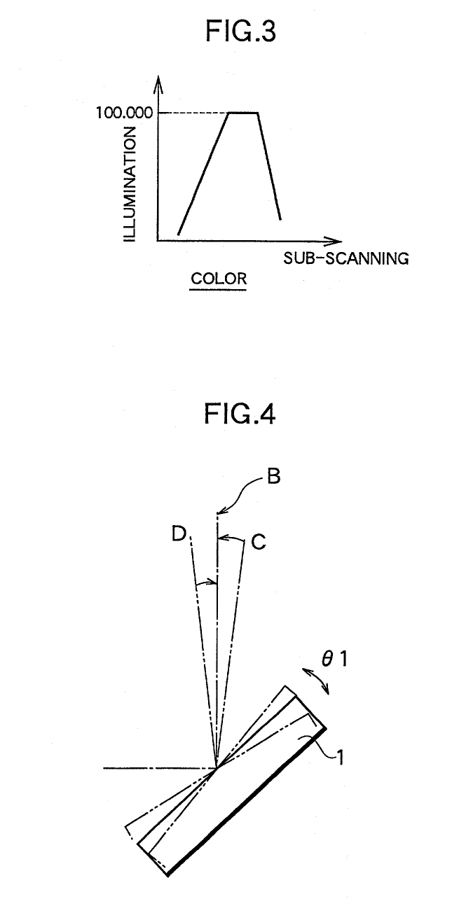

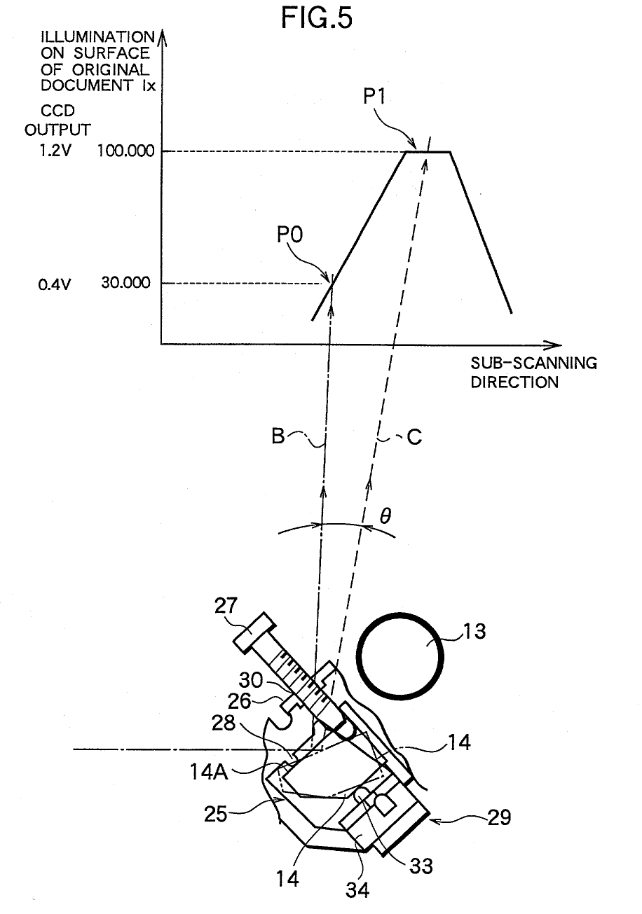

FIG. 1 is a schematic view showing a structure of an image reading apparatus according to an embodiment of the invention, and FIG. 5 is an enlarged view of a portion A of the image reading apparatus (color scanner) shown in FIG. 1.

An image reading apparatus 11 comprises a casing 12, a lamp 13, a first mirror 14, a second mirror 15, a third mirror 16, a reducing lens 17, a three line CCD sensor for color 18, a circuit board 19, a control panel 20 and an image processing apparatus 21.

The casing 12 is a box constituting an outer hull of the image reading apparatus 11. The lamp 13 and the like are stored in the casing 12. The casing 12 is provided at its upper side surface with an original document glass 22 on which an original document is placed, an SHD glass 23 and an SHD plate 24.

The lamp 13 comprises a halogen lamp, and is provided such that the lamp 13 faces the placed original document. The surface of an original document is irradiated with light emitted from the lamp 13, and reflected light projects the first mirror 14 as an image of the original document.

The first mirror 14 reflects light reflected from the surface of the original document in the set direction, and finally guides the light into the three line CCD sensor for color 18. The first mirror 14 is a rod-like member having a pentangular cross section. An upper side surface of the first mirror 14 is a reflection surface 14A.

The first mirror 14 is supported at its opposite ends by two first carriages 25. The first carriages 25 are members for rotatably supporting the first mirror 14. The first mirror 14 and the first carriages 25 constitute an optical axis adjusting mechanism which adjusts the optical axis such that the CCD output value detected by the circuit board 19 as an output value detecting mechanism described later becomes an appropriate value. Each of the first carriages 25 comprises a carriage base 26, an optical axis adjusting screw 27, a fixing/supporting projection 28 and an elastic supporting projection 29.

The carriage base 26 is a member for supporting the optical axis adjusting screw 27, the fixing/supporting projection 28 and the elastic supporting projection 29, thereby supporting the first mirror 14. The carriage base 26 is provided with a female screw portion 30, and the optical axis adjusting screw 27 is screwed into the female screw portion 30.

The optical axis adjusting screw 27 is a member for supporting the first mirror 14 at three points together with the fixing/supporting projection 28 and the elastic supporting projection 29. A tip end of the optical axis adjusting screw 27 is formed into a semi-spherical shape, and the tip end abuts against the first mirror 14 at one point. The optical axis adjusting screw 27 abuts against a reflection surface 14A of the first mirror 14 in a state in which the optical axis adjusting screw 27 is supported by the female screw portion 30, and the first mirror 14 can be turned by screwing the optical axis adjusting screw 27 or loosening the screw.

The fixing/supporting projection 28 is integrally provided on the carriage base 26, and abuts against the reflection surface 14A of the first mirror 14, thereby supporting the first mirror 14. A tip end of the fixing/supporting projection 28 is formed into a semispherical shape, and abuts against the reflection surface 14A of the first mirror 14 at one point. Only the fixing/supporting projection 28 is integrally formed on the carriage base 26 and does not move. Therefore, the first mirror 14 is turned around the fixing/supporting projection 28 in a state in which the first mirror 14 is supported by the fixing/supporting projection 28.

The elastic supporting projection 29 is mounted to the carriage base 26, and abuts against the surface opposite to the reflection surface 14A of the first mirror 14, and elastically supports the first mirror 14 in a state in which the adjustment by means of the optical axis adjusting screw 27 is permitted. The elastic supporting projection 29 comprises a projection 33 and a spring 34. A tip end of the projection 33 is formed into a semi-spherical shape, and abuts against the first mirror 14 at one point. The spring 34 elastically supports the projection 33 in a state in which the spring 34 is supported by the carriage base 26. As a result, the elastic supporting projection 29 elastically supports the first mirror 14.

With this, the first mirror 14 is stably supported at its three points by the optical axis adjusting screw 27, the fixing/supporting projection 28 and the elastic supporting projection 29, and is turned around the fixing/supporting projection 28. That is, the first mirror 14 is turned around the fixing/supporting projection 28 by screwing the optical axis adjusting screw 27 or loosening the screw. Then, the elastic supporting projection 29 supports the turning motion of the first mirror 14 around the fixing/supporting projection 28 to the opposite side, thereby stabilizing the turning motion. Further, by finely adjusting the turning angle of the optical axis adjusting screw 27, it is possible to finely adjust the turning angle of the reflection surface 14A of the first mirror 14 around the fixing/supporting projection 28. As a result, it is possible to precisely and finely adjust the optical axis of the light which is reflected by the first mirror 14.

The first carriages 25 are provided on the opposite ends of the rod-like first mirror 14, and the angle is adjusted by the opposite ends of the first mirror 14. The optical axis adjusting screws 27 of the first carriages 25 may independently be adjusted at the opposite sides, or may be connected to each other through a wire or the like so that the optical axis adjusting screws 27 can move associatively. If the two optical axis adjusting screws 27 are designed such that they move associatively through the wire or the like, the angle of the entire first mirror 14 can be adjusted by turning one of the optical axis adjusting screws 27.

The second mirror 15 and the third mirror 16 are mirrors for changing a direction of light which was reflected by the first mirror 14 by 180° by means of two reflections. The second mirror 15 and the third mirror 16 are integrally supported by a second carriage 36. Like the first carriage 25, the second carriage 36 may comprise a carriage base, an optical axis adjusting screw, a fixing/supporting projection and an elastic supporting projection, and optical axes of the mirrors 15 and 16 may be aligned with the designed value and fixed. If the second carriage 36 is formed into the same structure as that of the first carriage 25, it is possible to make the fine adjustment by means of the mirrors 14, 15 and 16. If the mirrors 15 and 16 are fixed, the optical axes of the mirrors 15 and 16 may slightly be deviated due to variation in parts or variation in assembling operation, but this deviation can be compensated by finely adjusting the first mirror 14.

The reducing lens 17 is a lens for focusing light which was reflected by the third mirror 16. The reducing lens 17 focuses light from the third mirror 16 and projects the light to the three line CCD sensor for color 18. The three line CCD sensor for color 18 is an image reading sensor which captures an image of the original document as it is, and converts the image into an electrical signal. The three line CCD sensor for color 18 outputs an electrical signal of strength corresponding to the amount of the projected light to the circuit board 19.

The circuit board 19 is a processing circuit which converts the electrical signal from the three line CCD sensor for color 18 into a digital signal. The circuit board 19 processes the original document image, and calculates the CCD output value in the RGB. The circuit board 19 constitutes an output value detecting mechanism which detects an output value of the three line CCD sensor for color 18 as the image reading sensor. The output value is varied in accordance with deviation of optical axis.

The control panel 20 has various control functions, and has a display section connected to the circuit board 19 for displaying the CCD output value. The control panel 20 can be formed into two patterns. In one of the patterns, the control panel 20 is integrally provided on an external surface of the image reading apparatus 11, and in the other pattern, the control panel 20 is formed as an independent device and appropriately connected to the circuit board 19. In any pattern, the control panel 20 is connected to the circuit board 19 and displays the CCD output value on the display section. Meanwhile, the CCD output value becomes an appropriate value when the optical axis of light reflected by the first mirror 14 and a peak position of illumination on the surface of the original document are aligned with each other. Therefore, an angle of the first mirror 14 is adjusted while confirming the CCD output value displayed on the control panel 20. That is, the optical axis adjusting screw 27 is turned such that the CCD output value becomes the appropriate value while confirming the display section of the control panel 20, thereby adjusting the angle of the first mirror 14.

The image processing apparatus 21 is a device for processing various image based on the signal from the control panel 20. The image processing apparatus 21 is incorporated in equipment such as a copying machine or facsimile machine together with the image reading apparatus 11, and carries out various image processings in accordance with the equipments.

The image reading apparatus 11 having the above10 described structure is operated in the following manner.

Light emitted from the first mirror 14 irradiates the surface of the original document, and is reflected by the surface of the original document, and projects to the first mirror 14 in the first carriage 25, and is reflected in the set direction. Light reflected by the first mirror 14 is reflected by the second mirror 15 and the third mirror 16 in the second carriage 36, for each, and projects to the reducing lens 17. The light focused by the reducing lens 17 and passing through the reducing lens 17 projects to the three line CCD sensor for color 18, and the original document image is converted into the electrical signal. The electrical signal in the three line CCD sensor for color 18 is converted into a digital signal by the processing circuit 19, and the data is sent to the image processing apparatus 21.

Also, an output value (CCD output value) of light received by the three line CCD sensor for color 18 is sent to the control panel 20 if necessary, and it is displayed on the display section. With this display, it is determined whether or not the CCD output value is an appropriate value.

By the determination of the CCD output value on the display section, if it is determined that the optical axis is deviated, the optical axis is adjusted in the following manner.

In a state in which the CCD output value is displayed on the display section of the control panel 20, the optical axis adjusting screw 27 is turned to adjust the optical axis. By turning the optical axis adjusting screw 27, the first mirror 14 is turned around the fixing/supporting projection 28 in a state in which the first mirror 14 is elastically supported by the elastic supporting projection 29, and the reflection surface 14A is turned. With this, the angle of the optical axis of the light reflected by the reflection surface 14A is varied. With this variation, light input to the three line CCD sensor for color 18 is varied, and the CCD output value displayed on the display section of the control panel 20 is also varied. The CCD output value becomes an appropriate value when the optical axis of light reflected by the first mirror 14 and the peak position of illumination on the surface of the original document are aligned with each other. Therefore, the optical axis adjusting screw 27 is turned while confirming the display section of the control panel 20, thereby adjusting the angle such that the CCD output value becomes the appropriate value (e.g., CCD output value of 1.2V, point P1 in FIG. 5 (illumination on the surface of the original document of 100,000 Lx)).

In FIG. 5, the optical axis adjusting screw 27 is screwed to turn the angle of the first mirror 14 by θ° (state shown with the broken line), and the optical axis B is moved to an optical axis C. With this, the CCD output is changed from a point P0 to a point P1. With this, light reflected by the original document is input to the three line CCD sensor for color 18 in its optimal state.

As a result, even if the optical axis is deviated due to variation in parts or assembling operation, it is possible to finely adjust the angle of the first mirror 14 by turning the optical axis adjusting screw 27 while confirming the actual CCD output. Therefore, it is possible to easily and precisely adjust the optical axis. Further, the optical axis can be adjusted appropriately only by the image reading apparatus 11 without using the particular inspecting device or the like, and the image failure can be resolved reliably.

In addition, although the present embodiment has been explained based on a color scanner, the present invention is not limited to the color scanner, and can also be applied to a monochrome scanner. In this case also, the same function and effect as those of the embodiment can be obtained.

Although the CCD sensor 18 was used as the image reading sensor, the present invention is not limited to the CCD sensor 18, and even if another image reading sensor is used, the optical axis can be adjusted appropriately.

What is claimed is:

1. An image reading apparatus which includes an image reading sensor for reading an image of an original document and converting the image into an electrical signal, which adjusts an optical axis of light irradiated and reflected by the original document to project the light on the image reading sensor and reads the image of the original document by the image reading sensor to convert the image into the electrical signal, wherein
the image reading apparatus further comprises an output value detecting mechanism which detects an output value of the image reading sensor which is varied in accordance with a deviation in the optical axis.

2. The image reading apparatus according to claim 1, wherein the image reading sensor comprises a CCD sensor.

3. An image reading apparatus which includes an image reading sensor for reading an image of an original document and converting the image into an electrical signal, which adjusts an optical axis of light irradiated and reflected by the original document to project the light on the image reading sensor and reads the image of the original document by the image reading sensor to convert the image into the electrical signal, wherein
the image reading apparatus further comprises an output value detecting mechanism which detects an output value of the image reading sensor which is varied in accordance with a deviation in the optical axis, and
an optical axis adjusting mechanism which adjusts the optical axis such that the output value detected by the output value detecting mechanism becomes an appropriate value.

4. The image reading apparatus according to claim 3, wherein the image reading sensor comprises a CCD sensor.

5. The image reading apparatus according to claim 3, wherein the optical axis adjusting mechanism comprises a mirror which reflects, in a set direction, light which is projected to the original document and reflected,
a fixing/supporting projection for supporting the mirror at a given position,
an optical axis adjusting screw which is provided opposed to the fixing/supporting projection and which supports the mirror together with the fixing/supporting projection, and which is screwed or loosening the screw to turn the mirror such that the optical axis of the light reflected by a surface of the mirror is adjusted, and
an elastic supporting projection which abuts against a surface of the mirror opposite to the fixing/supporting projection and the optical axis adjusting screw, and which elastically supports the mirror in a state in which the adjustment by the optical axis adjusting screw is permitted.

6. The image reading apparatus according to claim 3, wherein
a halogen lamp is used as a light source,
the image reading sensor comprises a three line CCD sensor,
the output value detecting mechanism includes a display section which displays a CCD output value,
the optical axis adjusting mechanism comprises a mirror which reflects, in a set direction, light which is projected to the original document and reflected, a fixing/supporting projection for supporting the mirror at a given position, an optical axis adjusting screw which is provided opposed to the fixing/supporting projection and which supports the mirror together with the fixing/supporting projection, and which is screwed or loosening the screw to turn the mirror such that the optical axis of the light reflected by a surface of the mirror is adjusted, and an elastic supporting projection which abuts against a surface of the mirror opposite to the fixing/supporting projection and the optical axis adjusting screw, and which elastically supports the mirror in a state in which the adjustment by the optical axis adjusting screw is permitted, and wherein
an angle of the mirror is adjusted by turning the optical axis adjusting screw of the optical axis adjusting mechanism while confirming the CCD output value on the display section, thereby adjusting the optical axis.
